(19) United States
(12) Patent Application Publication
(10) Pub. No.: US 2019/0333172 A1
(43) Pub. Date: Oct. 31, 2019

(54) SYSTEM AND METHOD FOR GENERATING VALUE PREDICTION OF COMMERCIAL REAL-ESTATE

(71) Applicant: Skyline AI Ltd., Tel Aviv (IL)

(72) Inventors: Or HILTCH, Rishon LeZion (IL); Guy ZIPORI, Kfar Saba (IL); Shmuel UR, D.N Misgav (IL)

(73) Assignee: Skyline AI Ltd., Tel Aviv (IL)

(21) Appl. No.: 16/391,945

(22) Filed: Apr. 23, 2019

Related U.S. Application Data
(60) Provisional application No. 62/662,333, filed on Apr. 25, 2018.

(51) Int. Cl. G06Q 50/16; G06Q 30/02; G06N 20/00

(52) U.S. Cl. CPC G06Q 50/16; G06N 20/00; G06Q 30/0206; G06Q 30/0202

(57) ABSTRACT

A system and method for generating value prediction of commercial real-estate properties (CREs), comprising: receiving a location pointer associated with at least one CRE, where a location pointer is an identifying parameter associated with the CRE; extracting metadata associated with the at least one CRE; analyzing the metadata of the CRE and of comparable properties (comparables), where the analysis includes matching real estate factors of the CRE and the comparables; and generating at least one value prediction of the CRE based on the analysis.

### CROSS-REFERENCE TO RELATED APPLICATIONS

This application claims the benefit of U.S. Provisional Application No. 62/662,333 filed on Apr. 25, 2018, the contents of which are hereby incorporated by reference.

### TECHNICAL FIELD

The present disclosure relates generally to real-estate assessment tools, and more specifically to a system and methods for evaluating real-estate property in real-time.

### BACKGROUND

Although technological advances have been introduced in most industrial areas to improve efficiency and productivity, the real-estate domain currently requires a massive use of manual labor to perform tedious and costly steps. Commercial real estate property (CRE) is property that is used solely for business purposes and is leased out to provide a workspace rather than a living space. Ranging from a single gas station to a huge shopping center, commercial real estate includes retailers of all kinds, office space, hotels, strip malls, restaurants, convenience stores, and the like.

One of the biggest advantages of commercial real estate is attractive leasing rates. In areas where the amount of new construction is either limited by land or by law, commercial real estate can have significant returns and offer considerable monthly cash flow. Industrial buildings generally rent at a lower rate, though they also have lower overhead costs compared to a commercial property. Commercial real estate also provides benefits of longer lease contracts with tenants compared to residential real estate. This gives a commercial real estate holder a considerable amount of cash flow stability, so long as their building is occupied by long-term tenants.

Restrictive rules and regulations are a primary deterrent for those wanting to invest in commercial real estate. Taxes, as well as the mechanics of purchase and maintenance responsibilities for commercial properties are obscured in legal documents that shift according to state, county, industry, size, zoning and various other parameters. Many current investors of commercial real estate either have specialized knowledge or employ people who do. Thus, the bar for entry into such investments can be significant.

Another hurdle for CRE investment is the increased risk brought with tenant turnover. With residence properties, the facilities requirements of a given tenant are almost the same as any previous or future tenant. With a commercial property, however, each tenant may have very different needs that require costly renovation or refurbishing. The building owner must adapt the space to accommodate each tenant's specialized needs. A commercial property with low vacancy but high tenant turnover may still lose money due to the cost of renovations for incoming tenants.

The process of commencing a commercial real estate investment typically starts with deal sourcing, where a search is perform for CREs that meet a buyer requirement's, e.g., within a set budget, desired potential return-on-investment (ROI), number of units, class of property or building, location, asset management fees and other ongoing expenses, and the like. After at least one deal is sourced, an underwriting process is performed, which typically includes comparables (comps). Comps referring to properties with characteristics that are similar to the sourced deal whose value is being sought.

Both the sourcing and the underwriting processes currently require significant manual labor and are therefore costly and require a long time to complete. It would be therefore advantageous to provide a solution that overcomes the deficiencies of the prior art by automatically and efficiently performing the sourcing and underwriting processes.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for generating value prediction for commercial real-estate properties (CREs), comprising: receiving a location pointer associated with at least one CRE, where a location pointer is an identifying parameter associated with the CRE; extracting metadata associated with the at least one CRE; analyzing the metadata of the CRE and of comparable properties (comparables), where the analysis includes matching real estate factors of the CRE and the comparables; and generating at least one value prediction of the CRE based on the analysis.

Certain embodiments disclosed herein also include a non-transitory computer readable medium having stored thereon instructions for causing a processing circuitry to perform a process, the process comprising: receiving a location pointer associated with at least one CRE, where a location pointer is an identifying parameter associated with the CRE; extracting metadata associated with the at least one CRE; analyzing the metadata of the CRE and of comparable properties (comparables), where the analysis includes matching real estate factors of the CRE and the comparables; and generating at least one value prediction of the CRE based on the analysis.

Certain embodiments disclosed herein also include a system for generating value prediction for commercial real-estate properties CREs, comprising: a processing circuitry; and a memory, the memory containing instructions that, when executed by the processing circuitry, configure the system to: receive a location pointer associated with at least one CRE, where a location pointer is an identifying parameter associated with the CRE; extract metadata associated with the at least one CRE; analyze the metadata of the CRE and of comparable properties (comparables), where the analysis includes matching real estate factors of the CRE and the comparables; and generate at least one value prediction of the CRE based on the analysis.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example network diagram utilized to describe the various disclosed embodiments.

FIG. 2 is an example flowchart describing a method for generating value prediction of CREs according to an embodiment.

FIG. 3 is a simulation of a value prediction and risk prediction according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

A system is configured to receive a query indicating location pointers associated with commercial real estate properties (CREs) and search for potential CREs throughout the web matching metadata associated with the CREs. The metadata comprises at least budget constraints, and may include additional parameters and factors. The search is performed through a plurality of direct and indirect sources to find potential CREs. Thereafter, an evaluation process is performed where the potential CREs are identified and analyzed using one or more machine learning techniques. The evaluation may be with respect to a current value of each CRE, as well an anticipated future value. Based on the analysis, metadata associated with each CRE is generated. Thereafter a comparison is made between the CREs based on the metadata and a score is generated for each CRE respective thereof. According to an embodiment, the score may further be generated by prediction of future characteristics associated with each CRE.

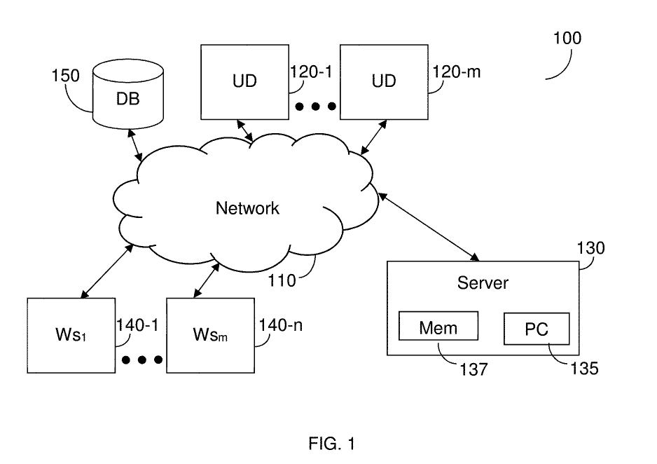

FIG. 1 is an example schematic diagram of an automated commercial real estate properties' (CREs) underwriting system 100 allowing to generate a value prediction of CREs according to an embodiment. A network 110 is used to communicate between different parts of the system 100. The network 110 may be the Internet, the world-wide-web (WWW), a local area network (LAN), a wide area network (WAN), a metro area network (MAN), and other networks capable of enabling communication between the elements of the system 100.

Optionally, one or more user devices 120-1 through 120-m (hereinafter user device 120 or user devices 120 for simplicity) are further connected to the network 110, where ‘m’ is an integer equal to or greater than 1. A user device 120 may be, for example, a personal computer (PC), a personal digital assistant (PDA), a mobile phone, a smart phone, a tablet computer, an electronic wearable device (e.g., connect glasses, connected watch, and the like), a smart television and other wired or mobile appliances, equipped with browsing, viewing, capturing, storing, listening, filtering, or managing capabilities enabled as further discussed herein below.

A server 130 is connected to the user device 120 and can communicate therewith via the network 110. The server 130 includes processing circuitry 135 and a memory 137. The processing circuitry 135 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

In another embodiment, the memory 137 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 135 to perform the various processes described herein.

Via the network 110, the server 130 is capable of connected to a plurality of web sources 140-1 through 140-n where ‘n’ is an integer equal to or greater than 1, hereinafter referred to as web source 140 or web sources 140 for simplicity. The web sources 140 may include data sources, web-pages, and the like. The web sources 140 may be associated with, for example, multiple listing sources, visual data sources, real-estate related sources, financial sources, e.g., stock-exchange APIs, a combination thereof, and so on.

A database 150 that stores metadata related to CREs transactions, data extracted from regulatory data sources or tax authorities, geographic information systems (GISs) and more is further connected to the network 110. In the embodiment illustrated in FIG. 1, the server 130 is connected to the database 150 through the network 110.

According to an embodiment, the server 130 receives at least one location pointer associated with at least one CRE. The location pointer may be received from a user device 120, via the network 110 and may be, for example, an address or a portion thereof, a geo-location, and other identifying parameters associated with the CRE.

Thereafter, the server 130 is configured to extract metadata associated with the at least one CRE from at least one web source 140 over the network 110. The metadata may include at least one of: visual data, natural language processed data, stock market performance, governmental data, a combination thereof, and the like.

The extracted metadata is then analyzed. In an embodiment, the metadata is composed of data items that are indicative of different aspects of the CRE. For example, a data item may be indicative of the size of the CRE, the number of units in the CRE, occupancy, and the like. In an embodiment, for data items composing the metadata that contain information that is insufficient for executing the analysis, data items associated with comps having real estate factors (hereinafter factors) that match the CRE above a certain threshold are retrieved, e.g., from a database, and a histogram of each data item is extracted. Thereafter, a histogram of each factor is correlated between the extracted metadata of the CRE and the comps, and the differences can then be further analyzed. This process allows separating different factors which are naturally associated with a CRE and analyzing them, e.g. determining a relationship between pairs of factors, such as year built and sale price, neighborhood and sale price, and the like.

Factors associated with a CRE may include how old a building is; whether the CRE has been renovated lately, whether a CRE has historic or vintage value; the current and previous real estate trends; number of stories; number of units; rent per unit; mean rent per square foot; cap rating; parking space, elevation relative to sea level or surrounding buildings; income distribution in the area; ages of nearby or current owners; distances between the CRE and various attractions, e.g., train stations, supermarkets, parks, restaurants, schools; financial data such as current interest rates, taxes on the CRE; distance to a downtown or business area; time series features of the CRE, which relate to a time window at which a CRE was sold (it may be sold in a low price in May 2015 since there was a poor general economic condition), and the like.

In an embodiment, CREs may be considered as comps when they share factors with the initial CRE above a predetermined threshold. The factors of the CRE and potential comparables are compared to each other, if they are determined to not only be in the same physical neighborhood, but also if they share a “virtual” neighborhood. A virtual neighborhood is when all CREs in it share real estate factors that are within a predetermined range of similarity, such that they can be treated as comps based on the CREs factors, factors related to the CRE's tenants, etc. Factors that are related to the CRE's tenants may be for example, the tenants' working place, the tenants' working hours, number of cars, etc. For example, if two CREs are located in distinct neighborhoods, but both are within a 5 minute walking distance to a train station, in both CREs most of tenants work in the public sector and the average number of cars for a family is 1.2, they may be considered to share a virtual neighborhood, and trends for both CREs may be compared one to another. In an embodiment, information from web sources, e.g., social media accounts, employment rates, geographic location of smartphones of the CRE's tenants, etc., is used to determine similar factors between CREs, such as demographics of populations surrounding the CREs.

In an embodiment, relationships between factors are determined using machine learning techniques, e.g., deep learning, neural networks, such as deep convolutional neural network, recurrent neural networks, decision tree learning, Bayesian networks, clustering and the like.

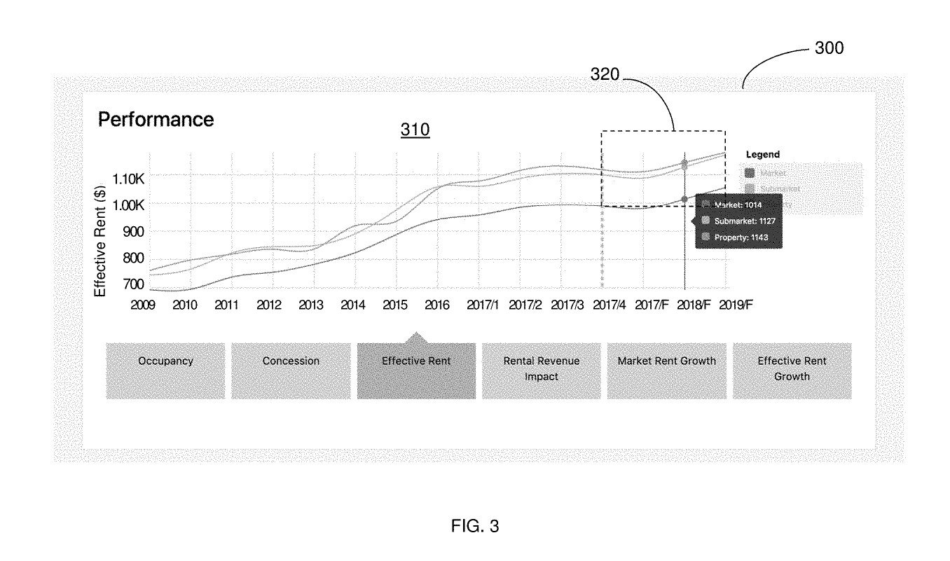

Based on the analysis of the factors, each identified data item is assigned a score which is to be used as a comparable numeric values. The score of each data item is generated based on all of the analyzed comps. In an embodiment, at least one value prediction and at least one risk prediction are generated based on the analysis. The value prediction is a numerical or visual representation of the aggregated metadata analyzed that may affect the sale price, internal rate of return (IRR), potential return on investment (ROI) and the like. The risk prediction is a numerical or visual representation of the sensitivities in the value prediction. Exemplary simulations of the value prediction and the risk prediction are depict herein below with respect of FIG. 3. The value prediction and risk prediction are then provided for display on the at least one user device 120.

In an embodiment, the value predictions are based tenant employment parameters.

For example, an algorithm to determine value predictions may be implemented that includes determining where occupants of a CRE work, including the percentages of the occupants working in various companies. A trend may be determined based on one or more work locations, e.g., the a financial trend of the companies. Finally, the impact of the trend on the CRE as to price and occupancy.

In order to determine where occupants work, social media sites may be searched, e.g., pages related to a tenant can accessed from a publicly available source, such as LinkedIn®, to determine their employer. Additionally, determining which people conduct an internet search the CRE along with a search on a specific work in the area can be used. A third method can use phone or social media geographic or satellite data indicating a specific location. A fourth method is to directly survey the tenants to determine where people living in or interested in living in the CRE work. The owner may be told by the tenants where they work when apply to purchase or rent a place within the CRE. Various other methods may be used as well.

The result of this determination is a collection of tenant or owner employment data within the CRE. An example result could be that 45% of occupants work at IBM, 20% within the public sector (teachers and others), 10% at Intel, 4% at Dell, and 21% unknown.

In addition to employment information of the occupants, financial trends of the identified companies may be determined. For publicly listed companies, the stock price can be tracked over a period of time, public announcements can be accessed, and various other information can be taken into account, such as news about the company, amount of internet job listings, including salary information therefrom, and the like. These can be used to determine the likelihood of growth or lack thereof in the near future.

The result can be presented in tabular form, such as the following example:

| Company Name | Percent of occupants | Growing | Salary impact |
|---|---|---|---|
| IBM | 45 | −15 | −10 |
| Public Sector | 20 | +05 | 0 |
| Intel | 10 | +05 | +08 |
| Dell | 4 | +25 | +15 |

The total hiring/growing impact of the above example is presented as the following equation:

45*−0.15+20*0.05+10*0.05+0.04*0.25=−4.25%

This result is input to a machine learning algorithm that can be used to predict the likely impact of the economic change on occupants moving into and out of the CRE. In an embodiment, the value prediction, the risk prediction, or both are determined by using machine learning, e.g., deep learning, neural networks, and the like, to analyze metadata and factors of the CRE and comps.

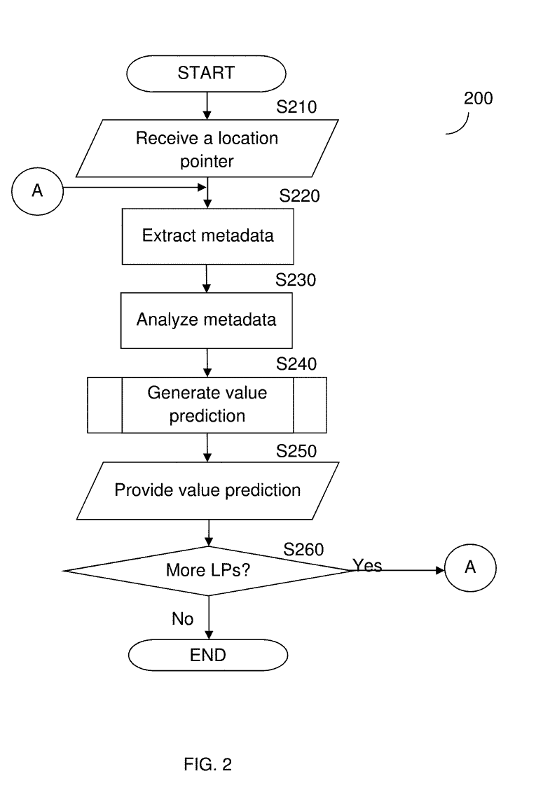

FIG. 2 is an example flowchart 200 illustrating a CREs' underwriting method allowing to generate a value prediction of a CRE, according to an embodiment. At S210, the operation starts when at least one location pointer associated with a CRE is received, e.g., from a user device. The location pointer may be, for example, an address, a geo-location, and other identifying parameters associated with the CRE.

At S220, metadata associated with the CRE is identified. The metadata may include at least one of: parameters associated with previous one or more transactions made with respect of one or more second CREs in proximity to the at least one CRE, previous transactions made with respect of the at least one CRE, and the like. The metadata may be extracted from, for example, one or more web sources.

At S230, the extracted metadata is analyzed as further described hereinabove with respect of FIG. 1. At S240, a value prediction is generated respective of the analysis. According to an embodiment, the value prediction further comprises a risk prediction associated with the at least one CRE.

At optional S260, the value prediction is provided as an output to, for example, the user device 120. At S270, it is checked additional location pointers have been received, and if so, execution continues with S220; otherwise, execution terminates.

FIG. 3 is an example simulation 300 of a value prediction and a risk prediction according to an embodiment. The graph 310 indicates historic market performance over time. According to this embodiment, characteristics such as the market value, submarket value and property value are depicted. Respective thereof, a forecast of the value is displayed 320, wherein the forecast indicates the behavior of said characteristics going forward. The graph 310 may be generated and displayed on a user device in response to a query regarding a specific CRE.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating value prediction of commercial real-estate properties (CREs), comprising:
receiving a location pointer associated with at least one CRE, wherein a location pointer is an identifying parameter associated with the CRE;
extracting metadata associated with the at least one CRE;
analyzing the metadata of the CRE and of comparable properties (comparables), wherein the analysis includes matching real estate factors of the CRE and the comparables; and
generating at least one value prediction of the CRE based on the analysis.

2. The method of claim 1, further comprising:
determining properties as comparables to the CRE if both the comparables and the CRE share real estate factors above a predetermined threshold.

3. The method of claim 2, wherein a CRE and comparables are determined to share a virtual neighborhood when shared real estate factors are within a predetermined range of similarity.

4. The method of claim 1, wherein metadata includes at least one of: visual data, natural language processed data, stock market performance, and governmental data.

5. The method of claim 1, wherein the value prediction is based on workplace trends of occupants of the CRE based on retrieved employment data.

6. The method of claim 1, wherein the value prediction is generated using machine learning techniques.

7. The method of claim 1, further comprising:
generating at least one risk prediction based on the analysis.

8. The method of claim 7, wherein the risk predication is generated using machine learning techniques.

9. A non-transitory computer readable medium having stored thereon instructions for causing a processing circuitry to perform a process, the process comprising:
receiving a location pointer associated with at least one CRE, wherein a location pointer is an identifying parameter associated with the CRE;
extracting metadata associated with the at least one CRE;
analyzing the metadata of the CRE and of comparable properties (comparables), wherein the analysis includes matching real estate factors of the CRE and the comparables; and
generating at least one value prediction of the CRE based on the analysis.

10. A system for generating value prediction of commercial real-estate properties (CREs), comprising:
a processing circuitry; and
a memory, the memory containing instructions that, when executed by the processing circuitry, configure the system to:
receive a location pointer associated with at least one CRE, wherein a location pointer is an identifying parameter associated with the CRE;
extract metadata associated with the at least one CRE;
analyze the metadata of the CRE and of comparable properties (comparables), wherein the analysis includes matching real estate factors of the CRE and the comparables; and
generate at least one value prediction of the CRE based on the analysis.

11. The system of claim 10, further comprising:
determine properties as comparables to the CRE if both the comparables and the CRE share real estate factors above a predetermined threshold.

12. The system of claim 11, wherein a CRE and comparables are determined to share a virtual neighborhood when shared real estate factors are within a predetermined range of similarity.

13. The system of claim 10, wherein metadata includes at least one of: visual data, natural language processed data, stock market performance, and governmental data.

14. The system of claim 10, wherein the value prediction is based on workplace trends of occupants of the CRE based on retrieved employment data.

15. The system of claim 10, wherein the value prediction is generated using machine learning techniques.

16. The system of claim 10, further comprising:
generate at least one risk prediction based on the analysis.

17. The system of claim 16, wherein the risk predication is generated using machine learning techniques.
